(19) United States
(12) Patent Application Publication
(10) Pub. No.: US 2013/0072270 A1
(43) Pub. Date: Mar. 21, 2013

(54) CODED VOCAL BEATBOXING EXPRESSION AND ITS USE IN A BEATBOXING GAME

(71) Applicant: Lucas MAJCHROWICZ, Mississauga (CA)

(72) Inventor: Lucas MAJCHROWICZ, Mississauga (CA)

(21) Appl. No.: 13/422,201

(22) Filed: Mar. 16, 2012

(30) Foreign Application Priority Data
Mar. 17, 2011 (CA) 2734323

(51) Int. Cl. G09B 15/00; A63F 13/00; G10L 25/48

(52) U.S. Cl. CPC G09B 15/00; G10L 25/48; A63F 13/00
USPC 463/7; 84/466

(57) ABSTRACT

A system for coding beatbox expressions. An expression including a series of elements that each represents a unique beatbox sound. Each element has an alphabetic portion relating to the enunciation of the element and a graphical portion relating to the musical category which the beatbox sound should imitate. An electronic game or teaching tool wherein a beatbox expression is visually displayed on a screen and the user provides input in the form of the beatbox sounds represented in the expression into a microphone. Using a CPU and custom software, feedback is provided regarding the quality of the user's performance.

### FIELD OF THE INVENTION

The invention relates to vocal beatboxing and a system used to code a vocal beatbox expression. The invention also relates to a vocal beatboxing electronic game.

### BACKGROUND OF THE INVENTION

Vocal beatboxing is a form of percussion that primarily involves the art of producing drum beats, rhythm and musical sounds using one's vocal system. The name beatbox was originally used to describe 1970's electronic drum machines and beatboxing was known as the act of making drum patterns and rhythms through the use of these devices. In addition, a style called vocal beatboxing developed. Originally vocal beatboxing copied the drum sounds made by electronic beatboxes but has since evolved to include all types of sounds, both musical and otherwise. In the last two decades the beatboxing industry has started to advance and gain popularity. It has become a respected form of art and music.

Traditionally, vocal beatboxing has been taught through imitation. Unfortunately, this requires extensive tutoring, practice and recall of a host of vocal beatbox sounds and how these sounds are generated. There remains a need to provide a system to record specific vocal beatboxing sounds in a systemized manner that assists in the sub-sequential vocalization thereof. Furthermore, there is a need for a way to express beatboxing music in written form.

The following disclosure outlines a method of communication of beatboxing techniques as well as a system to express beatboxing music in written form. In a preferred embodiment, an electronic beatboxing teaching tool or game is taught.

### SUMMARY OF THE INVENTION

The present invention provides beatbox expression comprising at least two musical categories and a series of beatbox elements. Each musical category includes a distinct graphical representation repetitively used in combination with the beatbox elements to visually classify the beatbox elements into at least two musical categories. Each beat box element comprises an alphabetic letter or combination of alphabetic letters having an annunciation used in combination with the musical category to vocalize each beatbox element of the beatbox expression.

In an aspect of of the invention is each musical category is selected from one of the following groups; musical instruments, groups of musical instruments, environmental noises, mechanical noises and animal noises.

In yet a further aspect of the invention, the series of beatbox elements is used in combination with a graph that is divided along one axis to indicate a timeline.

In a further aspect of the invention the graph is divided along a second axis to indicate pitch.

In yet a further aspect of the invention, the combination of alphabetic letters includes a first letter and a second letter. The first letter represents a dominant sound and the second letter represents a finish sound.

In a further aspect of the invention, the dominant sound is represented by a base letter and the finish sound is represented by a superscript.

In an alternative aspect of the invention, the dominant sound is represented by a base letter and the finish sound is represented by a subscript.

In a further aspect of the invention the musical category is further defined graphically.

In yet a further aspect of the invention, one of the musical categories is graphically represented by a circle around the alphabetic letter or combination of alphabetic letters.

In a further aspect of the invention, the musical categories are graphically distinguished by different sizes.

According to a further aspect of the invention, a beatbox game comprises a microphone for a user to input a beatbox sound, a sound system for amplifying the inputted beatbox sound, a visual display for displaying a beatbox expression to be reproduced by a user and an evaluator for producing a measure of the accuracy of the inputted beat box sound and the displayed beatbox expression. The beatbox expression has at least two musical categories and a series of beatbox elements. Each musical category includes a distinct graphical representation repetitively used in combination with the beatbox elements to visually classify the beatbox elements into at least two musical categories. Each beat box element comprises an alphabetic letter or combination of alphabetic letters having an annunciation used in combination with the musical category to vocalize each beatbox element of the beatbox expression.

### BRIEF DESCRIPTION OF THE DRAWINGS

Preferred embodiments of the invention are shown in the drawings, wherein:

FIG. 1 shows the various components of the human sound system;

FIG. 2 is a depiction of letter sounds divided into musical categories;

FIG. 3 is a depiction of where in the vocal system each letter sound originates;

FIG. 4 parts a through c shows examples of beatbox expressions; and

FIG. 5 depicts a beatbox sound catalogue including symbols for different musical categories and miscellaneous beatbox symbols.

FIG. 6 depicts a block diagram showing the various, components of an electronic beatboxing game.

### DETAILED DESCRIPTION OF THE PREFERRED EMBODIMENTS

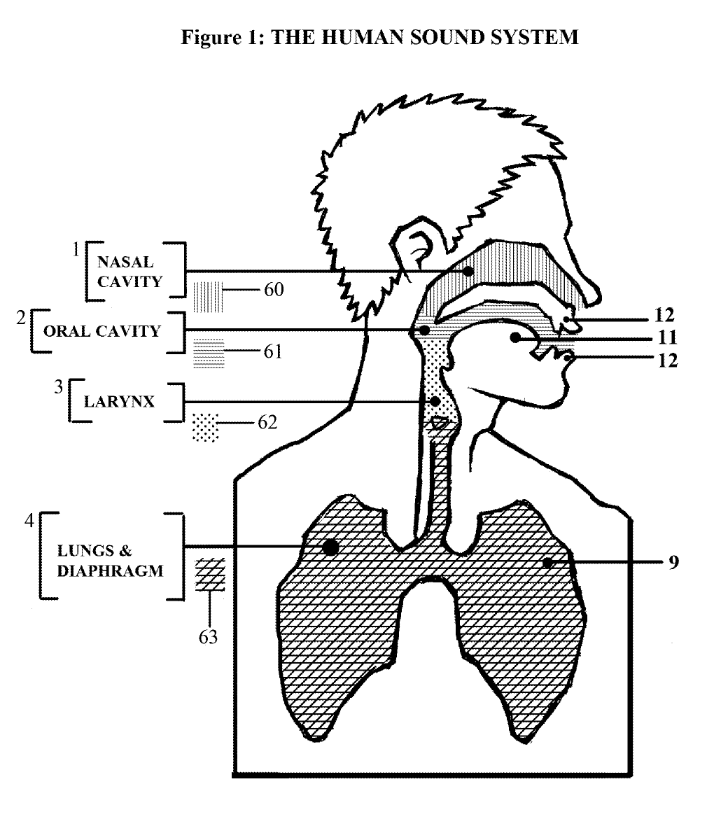

Vocal beatboxing is more easily understood with appreciation of how the human body creates the various noises. FIG. 1 illustrates different major components of the human sound system used to generate distinctly different sounds. Within the human body sound is produced when air is put in motion. The human sound system has been divided into four different categories namely the nasal cavity 1, the oral cavity 2, the larynx 3 and the lungs and diaphragm 4. Hatching patterns 60, 61, 62 and 63 represent the areas of the human sound system belonging to the nasal cavity 1, the oral cavity 2, the larynx 3 and the lungs and diaphragm 4 respectively. These are general categories used to initially assist a student vocal beatboxer in reproducing specific sounds. As will be further explained, there is some interaction and overlap between the categories.

The lungs and diaphragm 4 operate as the initiator and originator of any sound being produced. The lungs and diaphragm 4 are used to force air to move into and out of a user's body. The diaphragm is the muscle that activates the lungs to control the abdominal pressure and velocity of air going into and out of the lungs 9. Control of this part of the human sound system allows a vocal beat boxer to control the volume and intensity of a sound.

Air passing out of the lungs and diaphragm 4 enters into the throat 6 which contains the larynx 3, also known more commonly as the voice box. The larynx 3 can be varied to create specific tones and pitch of the generated sound. It is used extensively in bass categories, vocals, and scratching effects. The voice box or larynx is made up of cartilage and muscles which are capable of changing the properties of the generated sound being made as it travels up from the lungs by altering the cross sectional area of the opening forming the air transmission passage. The various shapes of the opening create different frequencies which allow beatboxers to create sounds such as whispers, murmurs, yelling, speaking and various percussion and vocal sounds.

The oral cavity 2 is located below the nasal cavity and connects the opening of the mouth to the throat 6. It takes a modified pressure coming from the lungs and diaphragm 4 and the larynx 3 to create unique sounds including vowels, consonants and words. The oral cavity uses the tongue 11 and lips 12 to further modify generated sounds produced by the larynx 3 and lungs and diaphragm 4. Typically sounds such as bass lines, snares or percussions and vocals are produced using the oral cavity. The oral cavity is used to articulate the generated sounds.

The nasal cavity connects the nostrils to the throat 6 and provides an additional airway to let air through while the oral cavity 2 alters the specific sound. In beatboxing, this is where humming or bass lines can be channeled. The nasal cavity 1 also takes part in articulating specific tones such as bass lines and tonal intonation by giving room or channels for the sounds to resonate within and through.

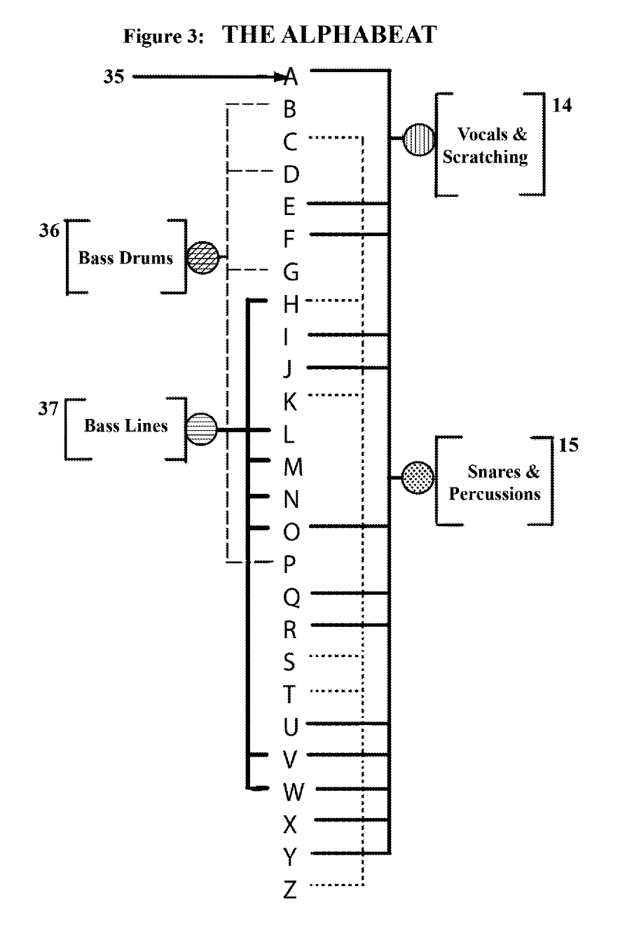

In order to further aid the beatboxer's understanding of how each beatbox sound is generated, the human sound system is further divided into “front”, “middle” and “back” portions as shown in FIG. 3, which correspond to specific regions where particular sounds are made. In this figure, letters are used to indicate the enunciation which they represent. The front portion 16 comprises the teeth, lips and tongue tip and is used to make sounds represented by the letters B, D, P, P, S, T and F. The middle portion 17 consists of the tongue body and palatals and is used to produce sounds represented by the letters K, G, D, H, J, L, Q, R and X. Generally, the tongue applies pressure to the roof of the mouth (also called the palatal walls) to create the middle sounds. The back portion 18 includes the back to the tongue, the voice box, lungs and larynx and is used to make sounds represented by the letters A, E, I, O, U, G, H, M, N, V, W, Y and Z.

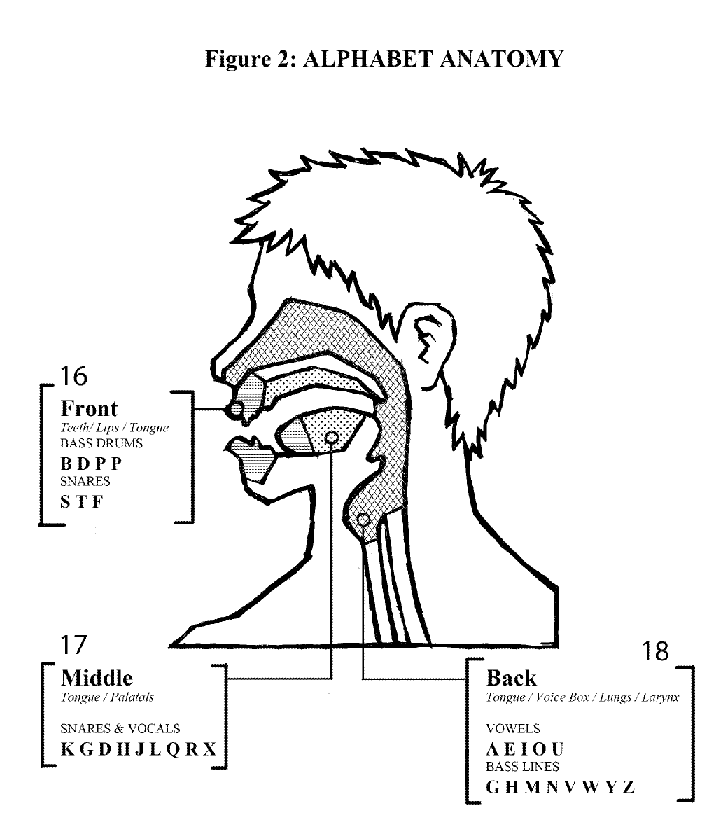

The alphabeat system as shown in FIG. 2 is helpful in teaching new beatboxers particular beat boxing sounds and is the basis for the coded vocal beatbox expression. Each of the alphabetic characters shown generally as 35 represents the sound that the letter produces. Each letter is associated with a musical category. For example the letters B, D, G and P are generally used to create noises that sound like a bass drum musical category 36, while the letters A, E, F, I, J, O, Q, R, U, V, W, X and Y are generally used to create noises that sound like a Disk jockey scratching on a turn table or vocal sounds. This is represented by the musical category Vocals and Scratching 14. The musical category Bass Lines 13 tends to include the letters H, L, M, N, O, V and W while the Snares and Percussions 15 musical category generally includes the letters C, H, K, S, T and Z. It should be noted that the letters can be used in musical categories apart from the one or two to which they correspond in FIG. 3. This is only an initial category guideline to help beat boxers learn the basics of sound generation. A musical category can represent any instrument, group of instruments, vocals or other noise groups, such as mechanical noises, animal noises or environmental noises.

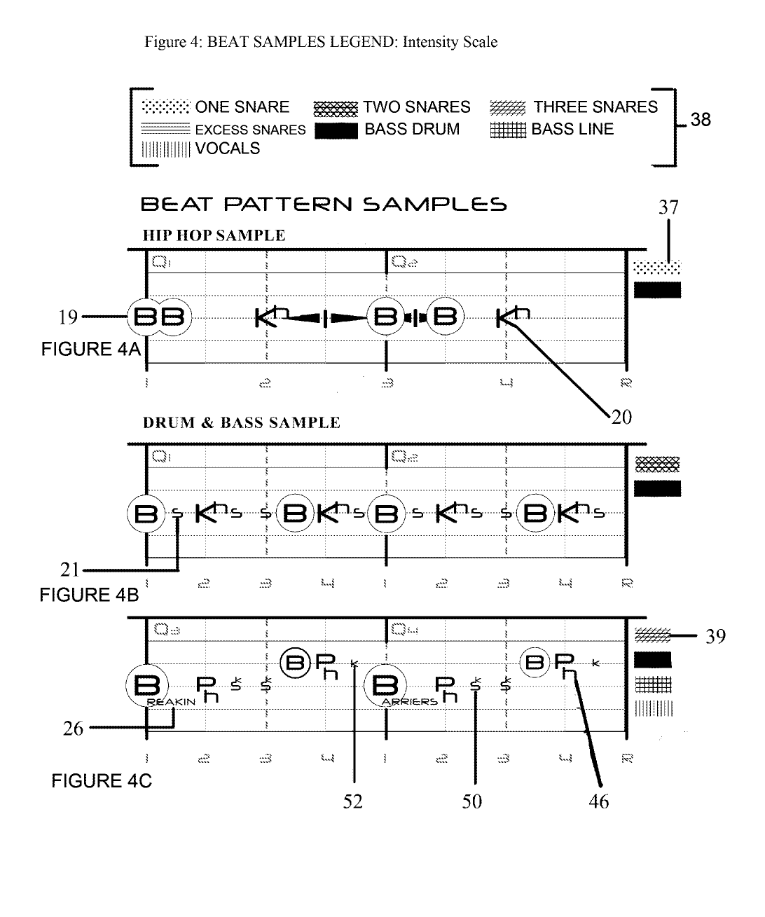

Examples of the coded beatbox expressions are shown in FIG. 4. A beatbox expression comprises musical categories as well as a series of beatbox elements 19. The musical elements 19 have an alphabetic portion as well as graphic components that define the musical category from which the sound should imitate. The alphabetic portion of some beatbox elements consists of one letter, for instance the S 21, which is representative of a sound similar to the enunciation of the letter S. Other beatbox elements contain two letters, for example the K^{H} 20. Elements with two letters have a dominant sound represented by the first letter and a finish sound represented by the second letter. In this case, a beatboxer would pronounce the element using the enunciation of the letter K and then finish the sound with the enunciation of a letter H. The base letter represents the dominant sound, while the finish sound can be represented by either a superscript or a subscript to the base letter. Although this example contains two letters it is possible that more than two letters could be used to produce an element that helps the beatboxer visually recall a beatbox sound.

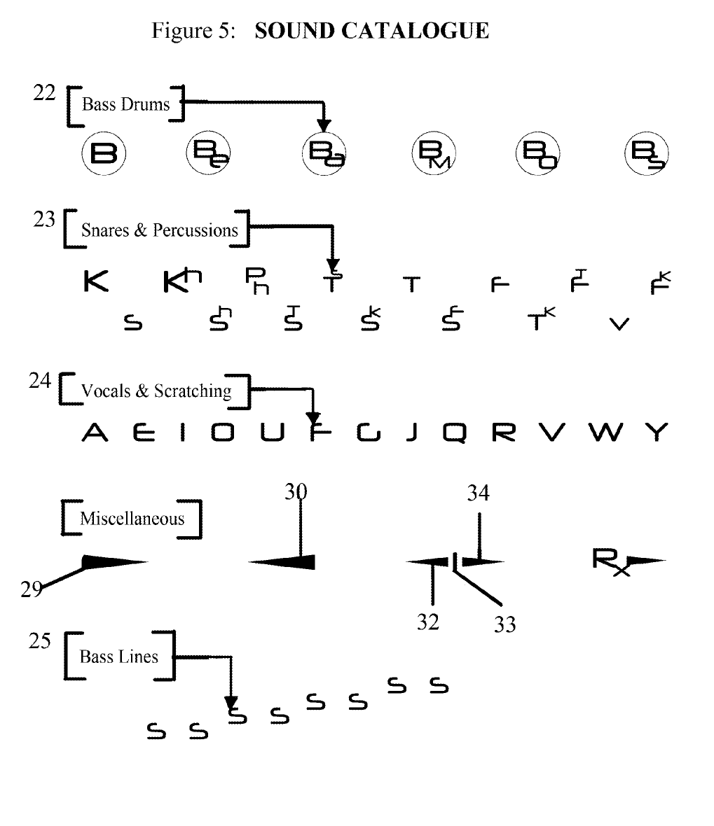

The second component of a beatbox element is a graphical component that is representative of the musical category that the sound should imitate. Each musical category is represented by a unique graphical element. In this embodiment, four examples of musical categories have been included (FIGS. 4 and 5); bass drums 22, snares and percussions 23, vocals and scratching 24 and bass lines 25. Bass drum sounds are represented by circling the alphabetic characters. When a beatboxer were to read the circle sounds they are reminded that the generated sound should imitate a sound produced by a bass drum. Snares and percussions are shown as alphabetic characters which are larger and bolder than other characters within the expression as seen in FIG. 4. The bass line musical categories are represented by smaller font sizes than that of the snares and percussion 25, as shown in FIG. 5. Vocals and scratching is shown in a yet smaller font size as shown by reference number 26 in FIG. 4 and will often use a beatbox element to begin the word in which the beatbox as shown is expressed. Although the preferred embodiment uses letter size and circles to indicate musical category, it can be appreciated that any symbol, size or colour could be used in combination with the alphabetic portion of the beatbox element to differentiate between musical categories.

As shown in FIG. 4, the beatbox expressions are displayed on a graph or musical staff, which has divisions on the X-axis to indicate the beat or timeline. It can also have divisions on the Y-axis to indicate pitch. In this particular embodiment, snares, percussions, bass lines and vocals have been shown to have different pitches, although any musical category could vary in pitch. Shaded areas 37 and 39 located on the right hand side of these expressions correspond to a legend 38 and can further define the musical category.

In a preferred embodiment, the shaded areas provide further information regarding the sounds included in the beatbox expression. For example, in FIG. 4a, there is only one snare drum element (K^{h} 20) as indicated by shaded area 37, whereas in FIG. 4c, three snare drum elements, P_{H} 46, S^{k} 50 and K 52, are present. This is indicated and shaded box 39 along the right hand side of the expression which corresponds with Three Snares in the legend 38.

FIG. 5 further defines a miscellaneous category 2) which contains various symbols including graduated lines, lines and letters not found within the sound catalogue. The first graduated line 29 to is similar to a decrescendo and indicates that the volume of a particular beatbox element would get softer over time. The second graduated line 30 is similar to a crescendo and indicates that the beatbox element would raise in volume. The third element 31 has three components. Element 32 represents a raise in volume similar to graduated line 30 and element 34 represents a decrease in volume similar to graduated line 29. The line 33 tells the beatboxer that they should take a breath at that point in the expression.

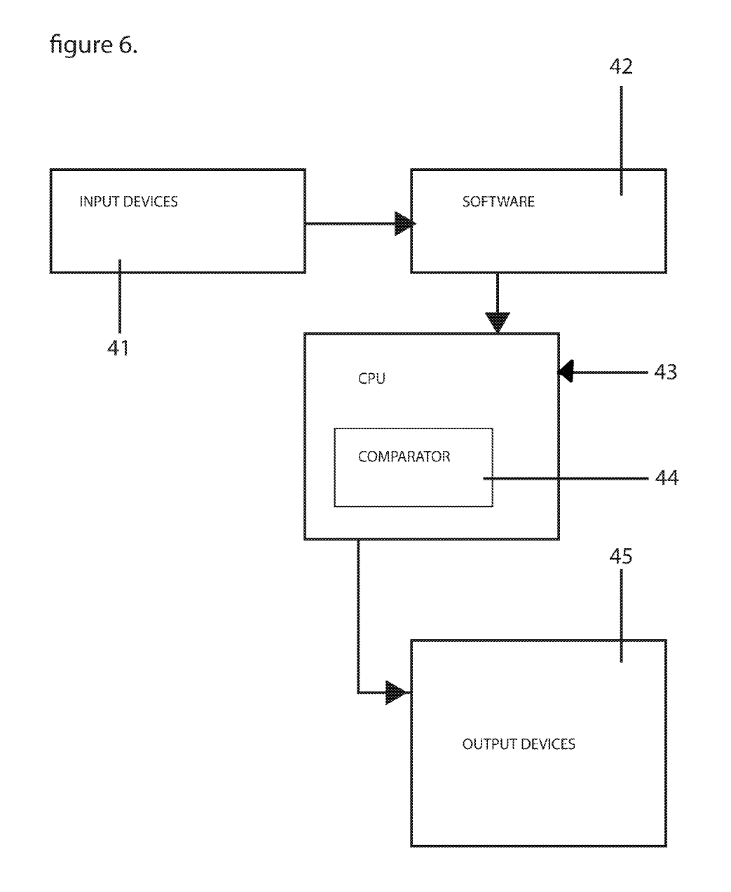

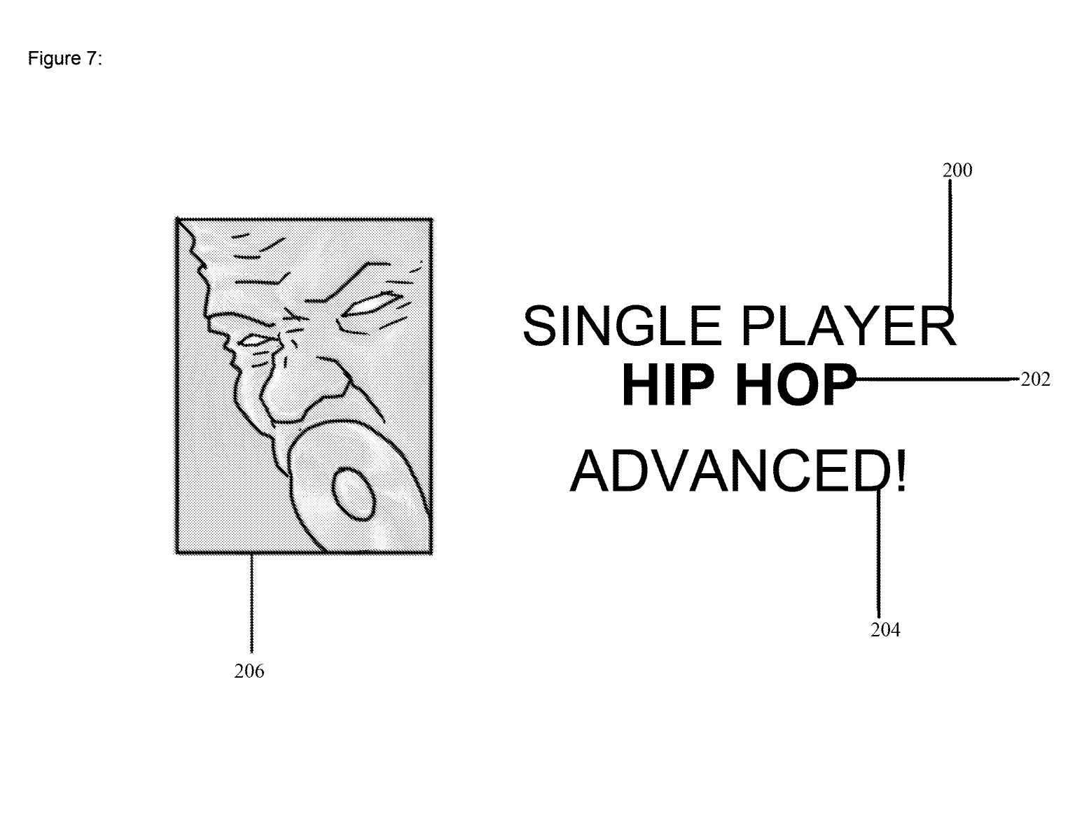

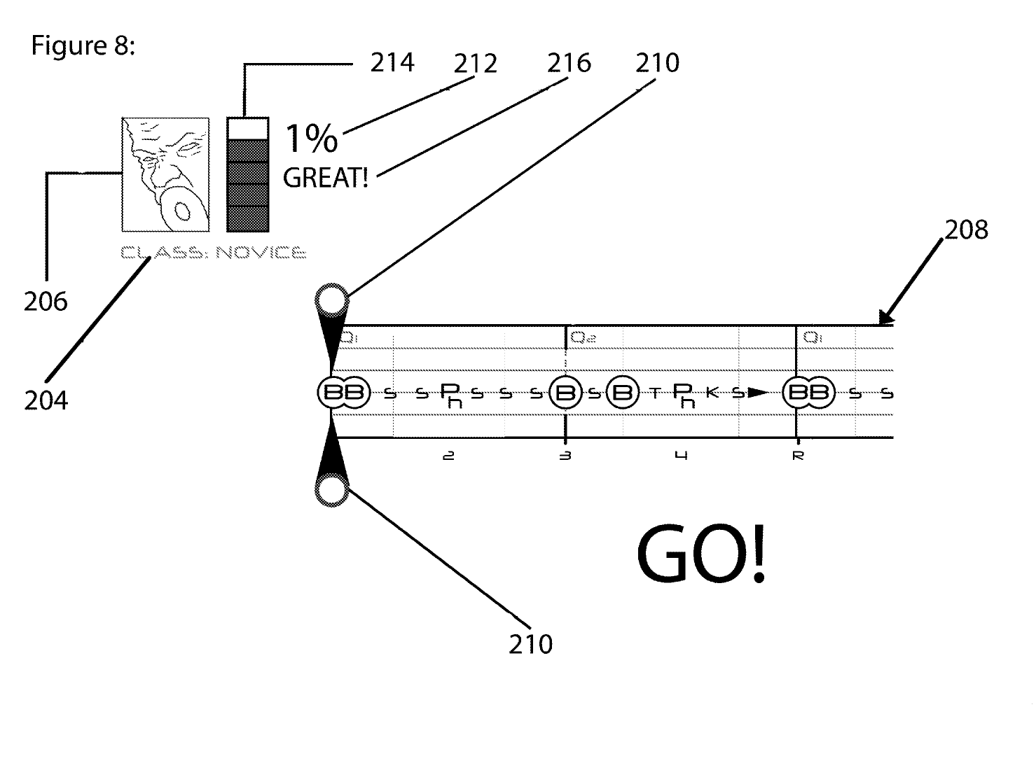

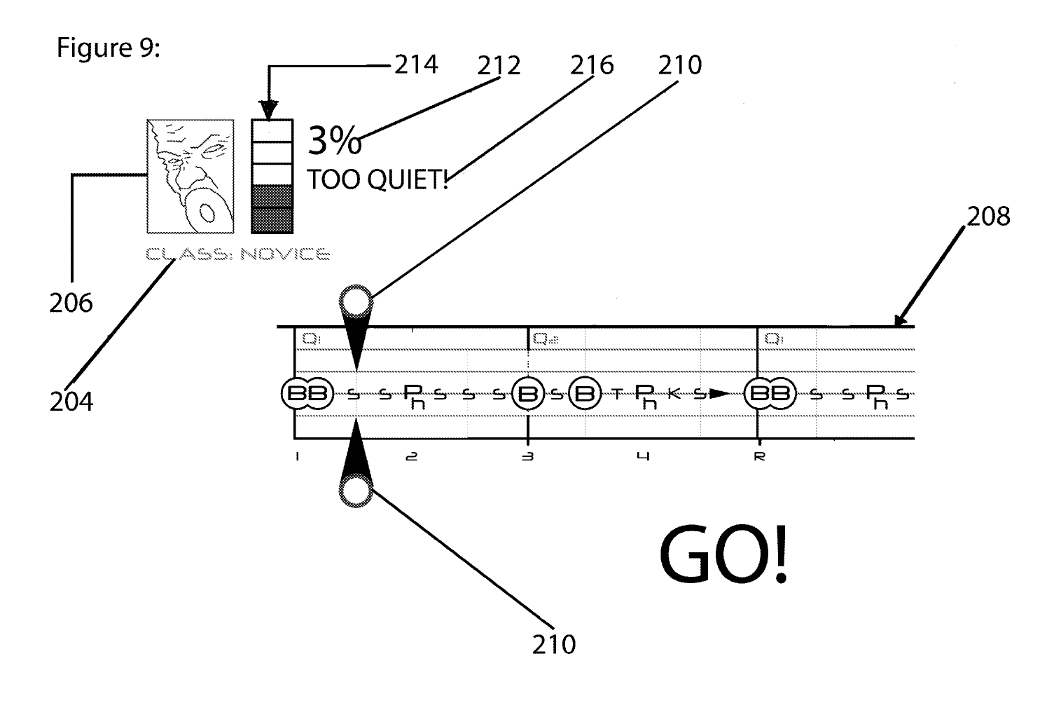

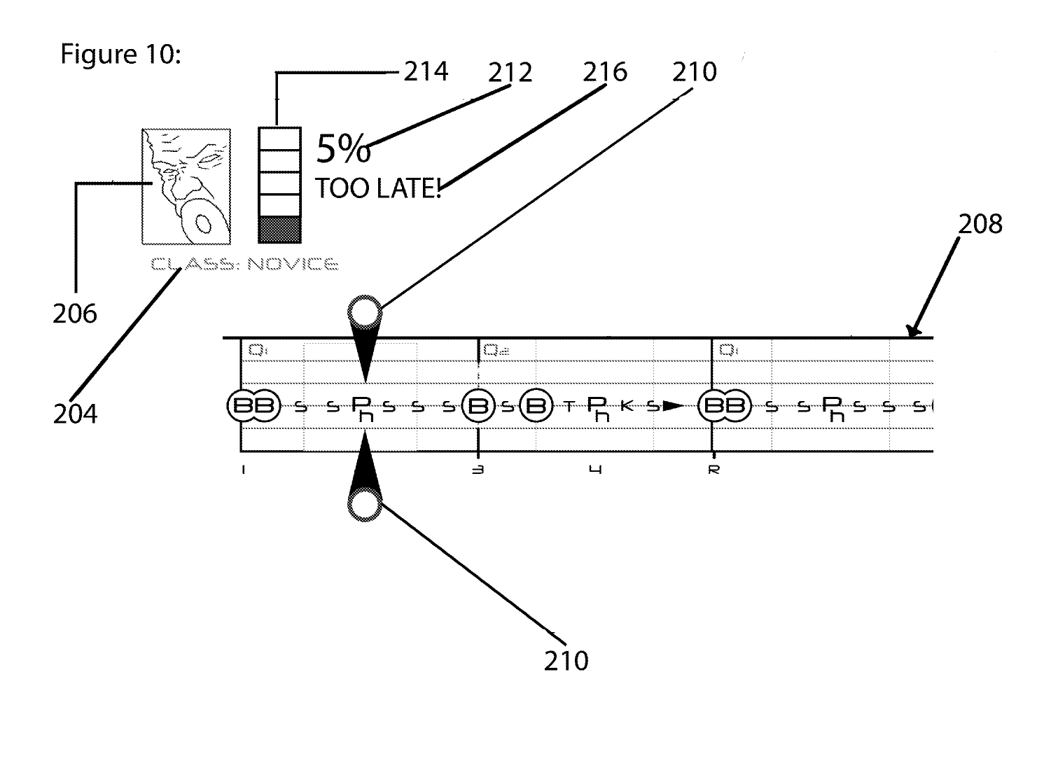

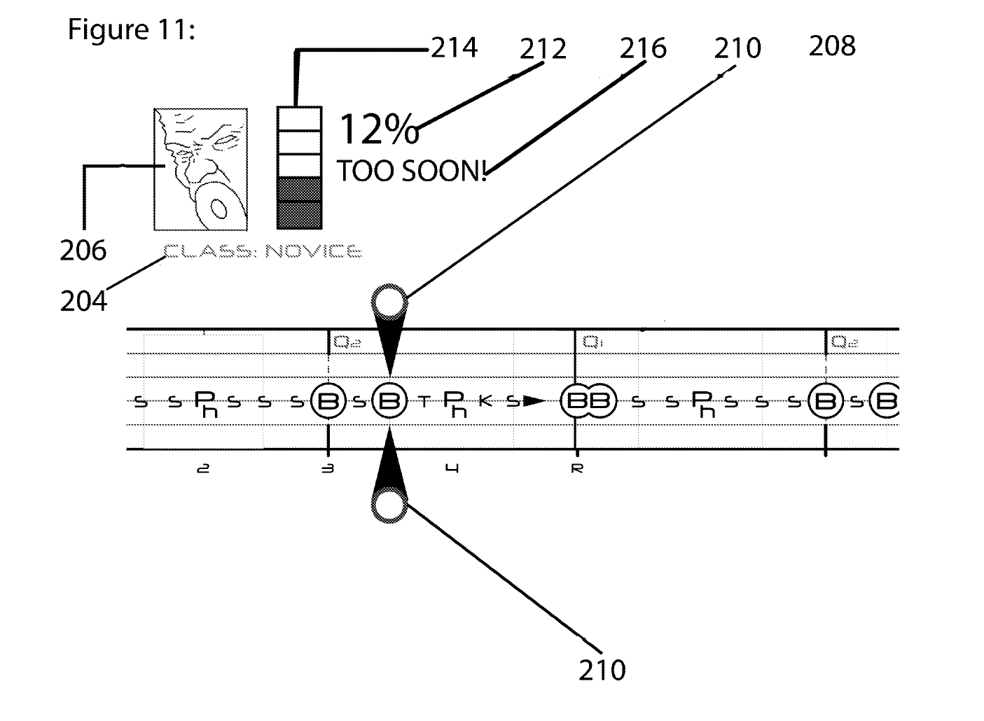

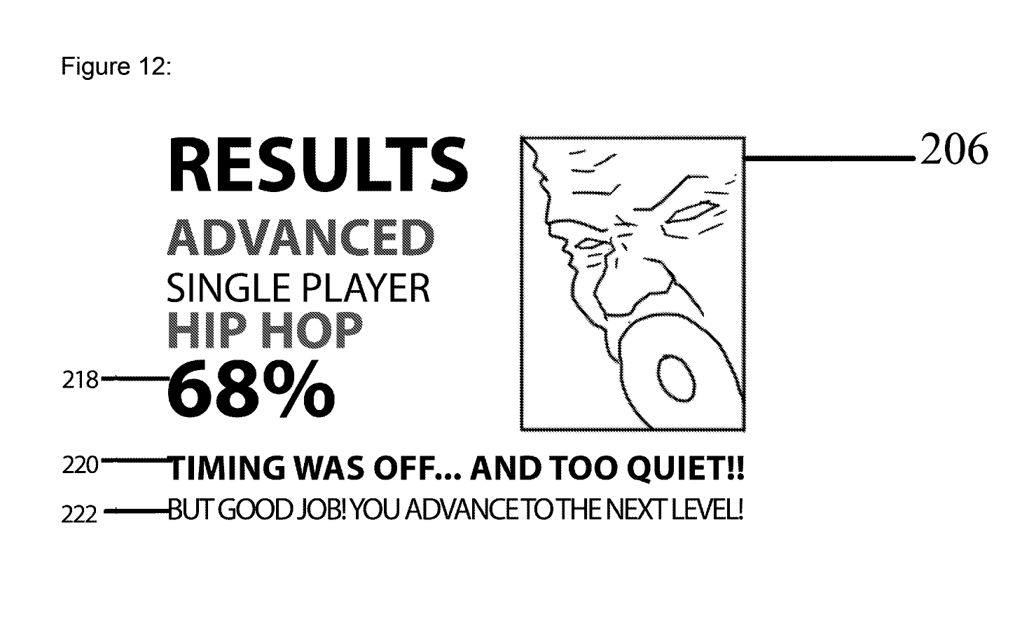

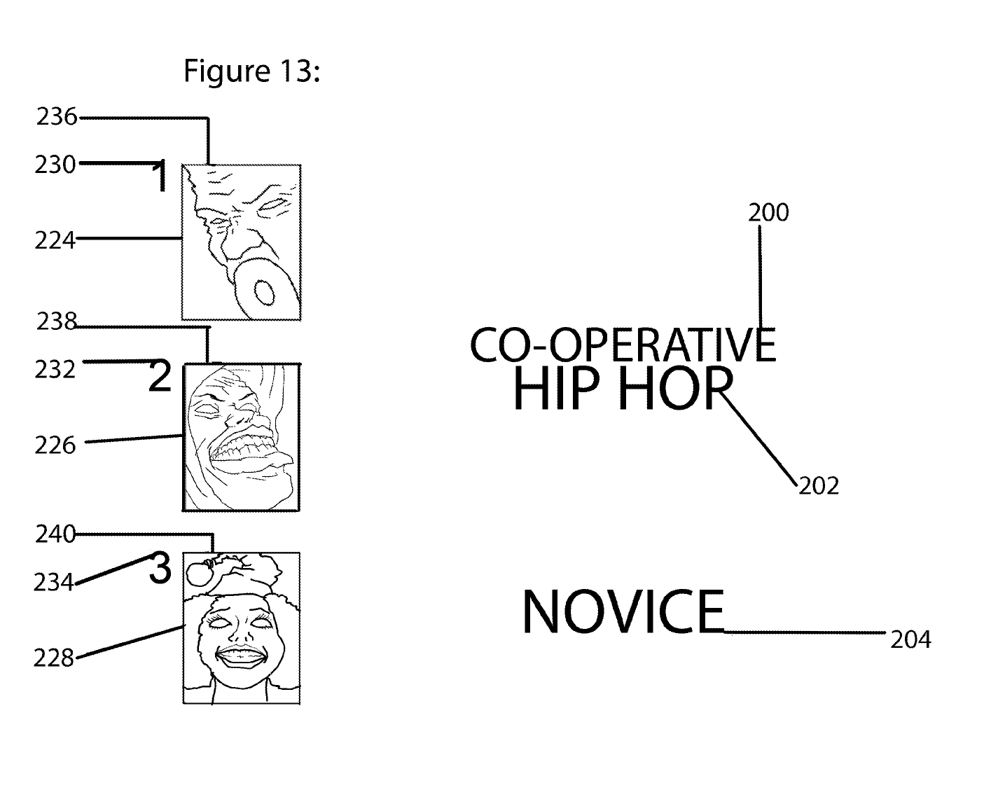

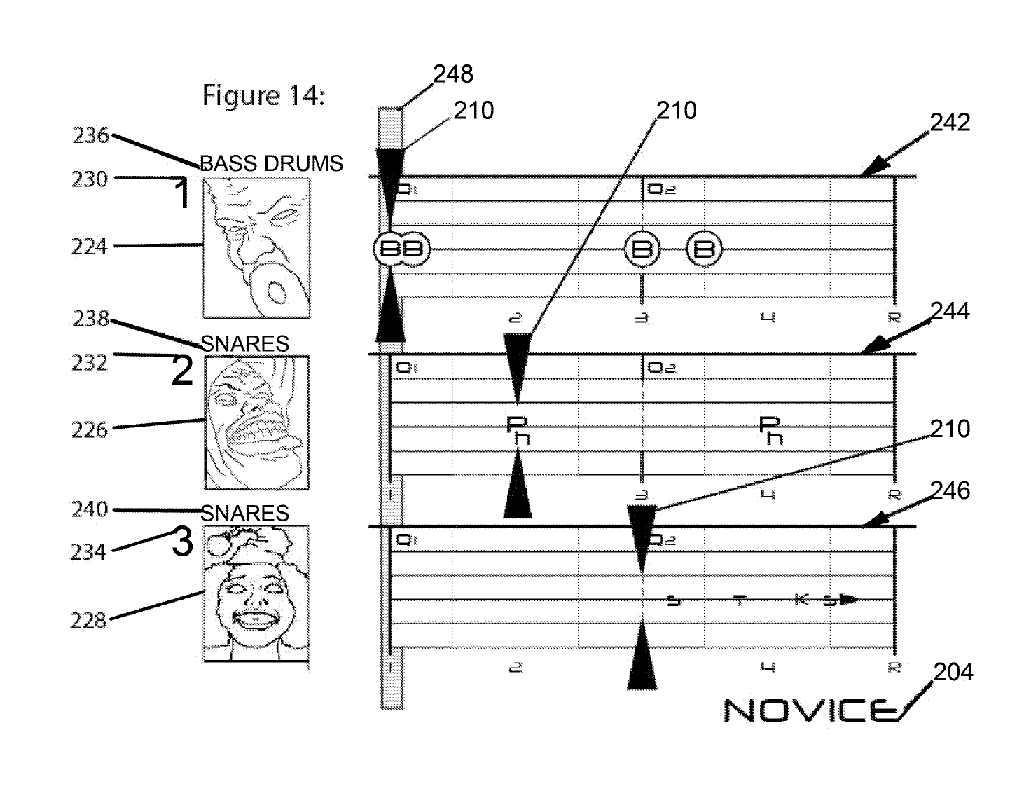

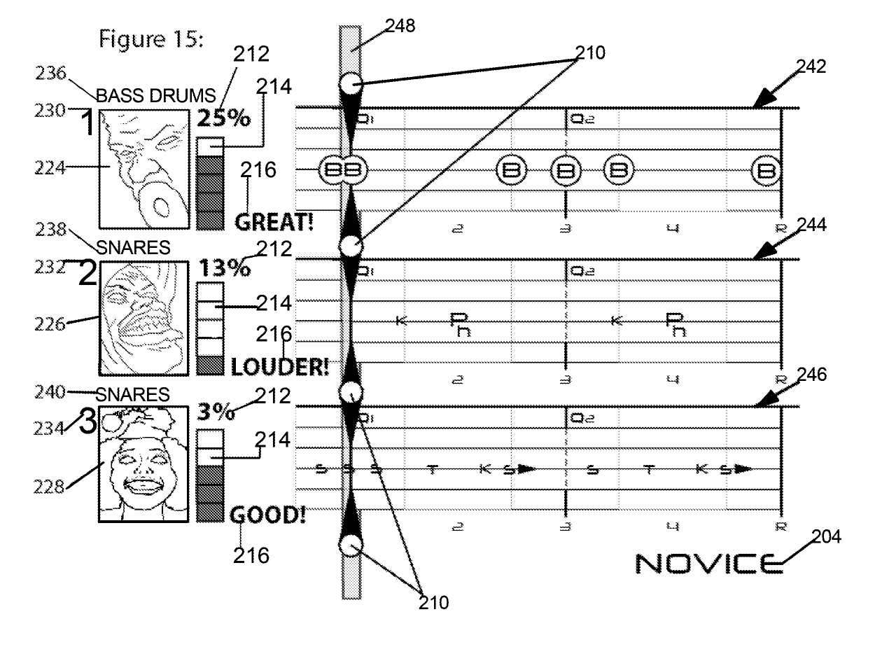

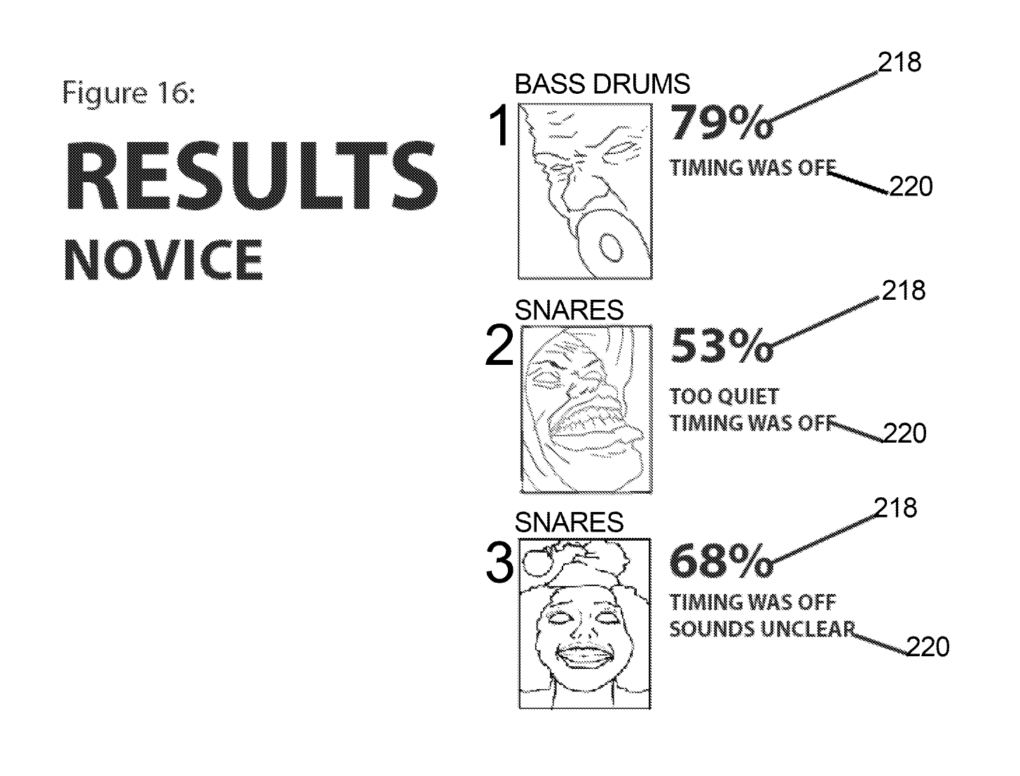

One application of this invention is an electronic beatbox game or teaching tool. The electronic game or teaching tool, as illustrated in FIG. 6, requires an input device 42 such as a microphone, software 42 to be used with a CPU 43 and output devices 45 such as screen on which to display the software and speakers. The player inputs the skill level so that the game or teaching tool uses a portion of the program specific to their particular level of beatboxing. Within the game, beatbox expressions are shown on the screen and the player tries to perform each beatbox expression into the microphone. This acts as an input into comparator 44 within the CPU 43 to be analyzed based on a pre-programmed correct vocal beatbox sound. The game then provides feedback on the player's performance. This feedback can be in the form of a score or ranking or messages such as “try again” or “good job”.

FIGS. 7-11 are screenshots taken from the single player version of the beatboxing game. FIG. 7 depicts a play screen which has a game mode title 200 that indicates the game mode. In this case the game mode was “single player”. This screen may also indicate the type of music chosen and the level of play by a music title 202 and level of play title 204 respectively. The screen also may include a depiction of a unique character 206 chosen by the player. FIG. 8 illustrates a portion of the coded beatbox expression 208 with indicators 210 to indicate where the player is in the beatbox expression. The game screen may also include a completion indicator 212, to illustrate the percentage of the expression the player has completed. Furthermore, 2 methods of feedback may be provided. The first is a bar measure 214 of how well the player is completing the overall beatbox expression. The second is secondary feedback 216 which may provide specific feedback to the player based on the performance of the most recent sequence of beatbox elements. Example of feedback are, but are not limited to “Great”, “Good”, “too late”, “too Early” and “Louder”. FIGS. 9 to 11 show examples of how the feedback indicators may change as the player progresses through the beatbox expression. As indicated in the figures, as the player makes more mistakes, the bar measure 214, is less filled in, indicating that the overall performance is poor. FIG. 12 is a screenshot of the results screen which may include an overall result indicator 218 that quantitatively indicates how well overall the player performed the beatbox expression. This information can be based on the comparator information. Qualitative feedback 220 on the overall performance may also be provided. Furthermore, a progression indicator 222 is provided to inform the player if they can move to the next level of the game.

The game is not exclusive to a single player but also includes a multiple player mode by using multiple microphones as individual input devices. In the multiple player mode, players compete against each other using the same beatbox expressions or work cooperatively to create a cohesive beatbox song. In the cooperative version each player performs a single musical category of the beatbox expression. Both versions of the game allow for beatboxers with different skill levels to play together. Before commencing the game players indicate their individual skill levels so that each musical category can be customized to the player's skill level.

FIGS. 13 to 16 are screen shots from the multiplayer mode of the game wherein 3 players would be participating. This is also may be called the cooperative mode. Similar to the contents of FIG. 7, FIG. 13 illustrates a play screen including the game mode title 200, a music title 202 and a level of play title 204. It also includes multiple character depictions 224, 226, and 228 which are characters chosen either by the game or the players to represent each of players. Additionally or alternatively each player could be represented by a player number 230, 232 and 234. Furthermore each of the players may choose or be assigned a musical category. This is indicated by the musical category title 236, 238, and 240 associated with each of the players.

FIG. 14 is a screen shot from the game at the point where the three players have just started the beatbox expression. Each player, 1, 2 and 3, have their own beatbox expression (242, 244 and 246 respectively) to be performed. Although the preferred embodiment separates the beatbox expression into parts for each player, it can be appreciated that alternative methods of display are possible. As in the single player mode, indicators 210 are provided for each player. Furthermore an indicator bar 248 is provided to mark the where the players should be in the beatbox expression.

FIG. 15 depicts a screen shot of the game at a point where all three players have commenced beatboxing. As in the single player mode each player is assigned a completion indicator 212, a bar measure 214 to provide visual feedback of their overall individual performances and secondary feedback 216.

FIG. 16 is a screenshot of a sample results screen which provides quantitative feedback 218 and qualitative feedback 220 for each player.

This game includes a teaching mode where the comparator software is used to aid the player in learning the sounds that the beatbox elements represent. The teaching tool plays the sound of a particular beatbox element though an output device such as a speaker and then asks the player to mimic the sound. The program can then provide feedback as to how well the player performed the element. As the player becomes more advanced, this same teaching technique can be expanded to full beatboxing expressions.

Although various preferred embodiments of the present invention have been described herein in detail, it will be appreciated by those skilled in the art,that variations may be made thereto without departing from the spirit of the invention or the scope of the appended claims.

The embodiments of the invention in which an exclusive property or privilege is claimed are defined as follows:

1. A beatbox expression comprising
at least two musical categories and a series of beatbox elements;
each musical category including a distinct graphical representation repetitively used in combination with said beatbox elements to visually classify said beatbox elements into said at least two musical categories; and
each beat box element comprising an alphabetic letter or combination of alphabetic letters having an annunciation used in combination with the musical category to vocalize each beatbox element of the beatbox expression.

2. A beatbox expression as claimed in claim 1 wherein said musical category is selected from the group consisting of musical instruments, groups of musical instruments, environmental noises, mechanical noises and animal noises.

3. A beatbox expression as claimed in claim 1 wherein in said series of beatbox elements are used in combination with a graph that is divided along one axis to indicate a timeline.

4. A beatbox expression as claimed in claim 3 wherein said graph is divided along a second axis to indicate pitch.

5. A beatbox expression as claimed in claim 1 wherein said combination of alphabetic letters includes a first letter and a second letter; wherein said first letter represents a dominant sound and said second letter represents a finish sound.

6. A beatbox expression as claimed in claim 5 wherein said dominant sound is represented by a base letter and said finish sound is represented by a superscript.

7. A beatbox expression as claimed in claim 5 wherein said dominant sound is represented by a base letter and said finish sound is represented by a subscript.

8. A beatbox expression as claimed in claim 1 wherein the musical category is further defined graphically.

9. A beatbox expression as claimed in claim 1 wherein one of said musical categories is graphically represented by a circle around said alphabetic letter or combination of alphabetic letters.

10. A beatbox expression as claimed in claim 1 wherein said musical categories are graphically distinguished by different font sizes.

11. A beatbox expression as claimed in claim 9 wherein said musical categories are graphically distinguished by different font sizes.

12. A beatbox game comprising a microphone for a user to input a beatbox sound, a sound system for amplifying the inputted beatbox sound, a visual display for displaying a beatbox expression to be reproduced by a user and an evaluator for producing a measure of the accuracy of the inputted beat box sound and said displayed beatbox expression; and wherein said beatbox expression comprises
at least two musical categories and a series of beatbox elements;
each musical category including a distinct graphical representation repetitively used in combination with said beatbox elements to visually classify said beatbox elements into said at least two musical categories; and
each beat box element comprising an alphabetic letter or combination of alphabetic letters having an annunciation used in combination with the musical category to vocalize each beatbox element of the beatbox expression.
